(19) United States
(12) Patent Application Publication
(10) Pub. No.: US 2007/0126360 A1
(43) Pub. Date: Jun. 7, 2007

(54) Plasma display device

(75) Inventors: Yasunobu Hashimoto, Kawasaki (JP); Nobuhiro Iwase, Miyazaki (JP); Tomokatsu Kishi, Yokosuka (JP); Masayuki Shibata, Yokohama (JP)

Correspondence Address: MCDERMOTT WILL & EMERY LLP, 600 13TH STREET, N.W., WASHINGTON, DC, 20005-3096, US

(73) Assignee: FUJITSU HITACHI PLASMA DISPLAY LIMITED

(21) Appl. No.: 11/634,105

(22) Filed: Dec. 6, 2006

(30) Foreign Application Priority Data
Dec. 6, 2005 (JP) JP2005-351593

(51) Int. Cl. H01J 17/49

(52) U.S. Cl. 313/584

(57) ABSTRACT

A small-sized full HD plasma display device with high luminance is to be provided. The plasma display device according to the present invention comprises: first and second substrates; first and second electrodes formed on the first substrate so as to generate sustain discharge on the first substrate; and third electrodes formed on the second substrate so as to generate address discharge with the second electrodes, wherein the first to third electrodes form one pixel including cells of R, G and B, display of 1920×1080 pixels can be made, a length of a diagonal line of a display screen is shorter than 132 cm, an interlace drive is used, almost half of the third electrodes are connected to a drive circuit from an upper side of a panel, and the rest of the third electrodes are connected to the drive circuit from a lower side of the panel.

### CROSS-REFERENCE TO RELATED APPLICATION

The present application claims priority from Japanese Patent Application No. JP 2005-351593 filed on Dec. 6, 2005, the content of which is hereby incorporated by reference into this application.

### TECHNICAL FIELD OF THE INVENTION

The present invention relates to a plasma display device.

### BACKGROUND OF THE INVENTION

A plasma display device is a large flat-type display and has expanded its market as a flat screen TV for home use. However, in recent years, there has been an increasing demand for higher definition, and the so-called full HD display having 1920×1080 pixels has been under development.

### SUMMARY OF THE INVENTION

However, the full HD plasma display device has the problems that the pixel size is reduced and the luminance is decreased and that the electrode pitch is narrowed and the manufacturing yield is reduced. For this reason, the size of the full HD plasma display device under development is large, and the smallest size thereof is 50 inch according to the technical release at present.

An object of the present invention is to provide a small-size full HD plasma display device.

The plasma display device according to the present invention comprises: first and second substrates; first and second electrodes formed on the first substrate so as to generate sustain discharge on the first substrate; and third electrodes formed on the second substrate so as to generate address discharge with the second electrodes, wherein the first to third electrodes form one pixel including cells of R (red), G (green) and B (blue), display of 1920×1080 pixels can be made, a length of a diagonal line of a display screen is shorter than 132 cm, an interlace drive is used, almost half of the third electrodes are connected to a drive circuit from an upper side of a panel, and the rest of the third electrodes are connected to the drive circuit from a lower side of the panel.

Since the interlace drive is used, the scan time can be shortened and the display discharge time can be made longer. By this means, the higher luminance can be realized. Further, since the single scan can be realized, the third electrodes can be alternately extended from the upper and lower sides of the panel, and the pitch of the extended electrodes can be doubled. Therefore, the manufacturing yield can be improved.

### BRIEF DESCRIPTIONS OF THE DRAWINGS

FIG. 1 is a diagram showing a configuration example of a plasma display device according to a first embodiment of the present invention;

FIG. 2 is an exploded perspective view showing a configuration example of a plasma display panel according to the first embodiment of the present invention; and

FIG. 3 is a diagram showing an example of 1 frame of an image according to the first embodiment of the present invention.

### DESCRIPTIONS OF THE PREFERRED EMBODIMENTS

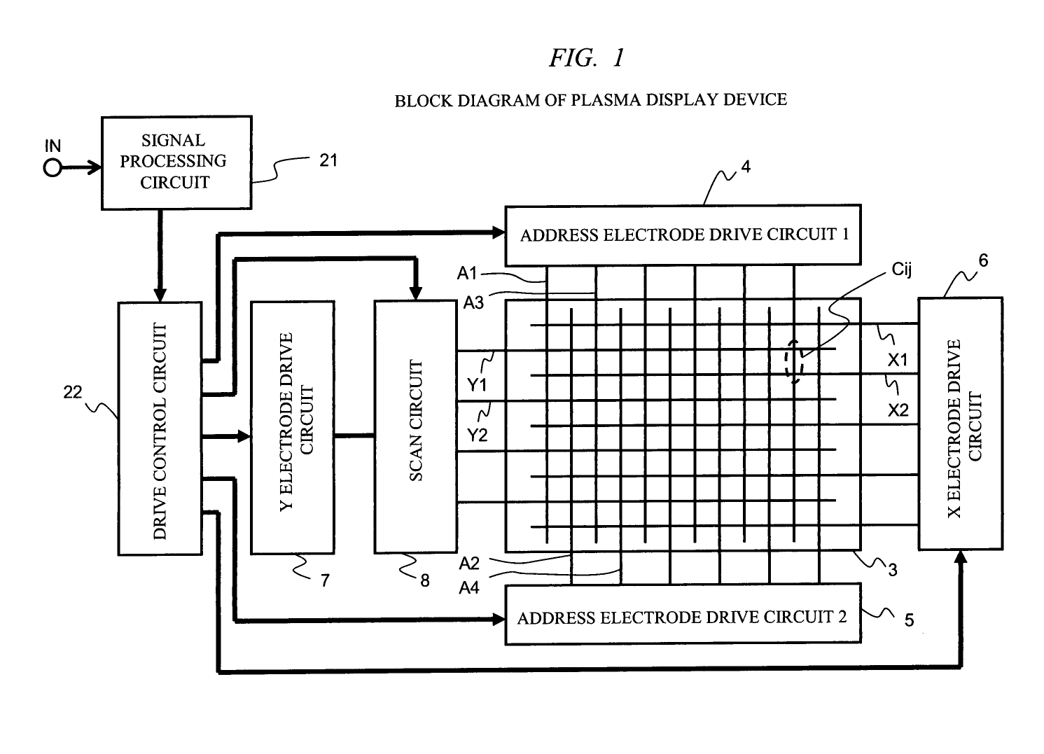

FIG. 1 is a diagram showing a configuration example of a plasma display device according to a first embodiment of the present invention. A signal processing circuit 21 processes signals inputted from an input terminal IN and outputs the same to a drive control circuit 22. The drive control circuit 22 controls an X electrode drive circuit 6, a Y electrode drive circuit 7, a scan circuit 8 and address electrode drive circuits 4 and 5. The X electrode drive circuit 6 supplies a predetermined voltage to a plurality of X electrodes (X1, X2, . . . ). Hereinafter, each X electrode (X1, X2, . . . ) and a plurality of X electrodes are collectively referred to as X electrode Xi and i thereof indicates a subscript. The Y electrode drive circuit 7 supplies a predetermined voltage to a plurality of Y electrodes (Y1, Y2, . . . ) via the scan circuit 8. Hereinafter, each Y electrode (Y1, Y2, . . . ) and a plurality of Y electrodes are collectively referred to as Y electrode Yi and i thereof indicates a subscript. The address electrode drive circuits 4 and 5 supply a predetermined voltage to a plurality of address electrodes (A1, A2, . . . ). Hereinafter, each address electrode (Al, A2, . . . ) and a plurality of address electrodes are collectively referred to as address electrode Aj and j thereof indicates a subscript.

Also, in a plasma display panel 3, Y electrodes Yi and X electrodes Xi form columns extending in a horizontal direction, and address electrodes Aj form rows extending in a vertical direction. The Y electrodes Yi and the X electrodes Xi are alternately disposed with respect to the vertical direction. Display cells Cij are formed at intersections between the pairs of X electrodes and Y electrodes for generating sustain discharge and the address electrodes Aj. The group of RGB of the display cell Cij corresponds to a pixel, and thus the plasma display panel 3 can display a two-dimensional image. A full-spec HD TV includes 1920 (horizontal direction)×1080 (vertical direction) pixels. Note that, in this embodiment, since the X electrode and the Y electrode are commonly used for two pixels other than the X electrode disposed at the end of the panel, 541 X electrodes and 540 Y electrodes are disposed. The cell pitch is 0.16 mm×0.48 mm. Straight ribs are used for ribs.

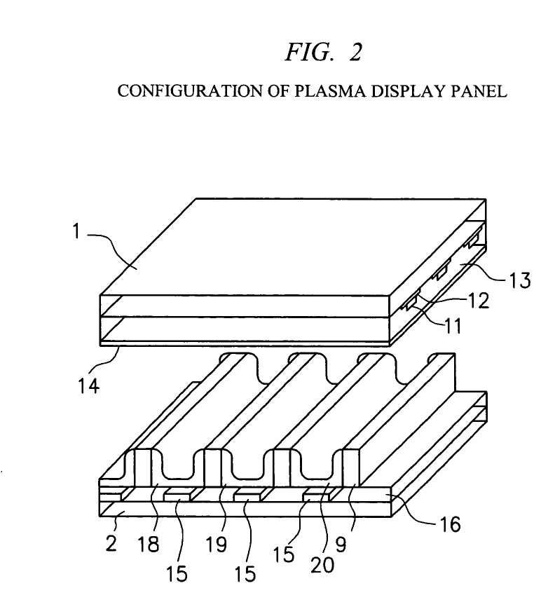

FIG. 2 is an exploded perspective view showing a configuration example of the plasma display panel 3 according to this embodiment. Bus electrodes 11 are formed on transparent electrodes 12. Each pair of the bus electrode 11 and the transparent electrode 12 corresponds to the X electrode Xi or the Y electrode Yi in FIG. 1. The X electrode Xi and the Y electrode Yi are alternately formed on a front glass substrate 1, and a dielectric layer 13 for the insulation from a discharge space is deposited thereon so as to cover the same. An MgO (magnesium oxide) protective layer 14 is deposited further thereon. On the other hand, the address electrodes 15 correspond to the address electrodes Aj in FIG. 1 and are formed on a rear glass substrate 2 which is disposed so as to be opposite to the front glass substrate 1, and a dielectric layer 16 is deposited thereon. A red phosphor layer 18, a green phosphor layer 19 and a blue phosphor layer 20 are deposited further thereon. The phosphor layers 18, 19 and 20 for the respective colors of red, blue and green are arranged and coated in a stripe shape on inner surfaces of the barrier ribs 9. The phosphor layers 18 to 20 are excited by the discharge between the X electrode Xi and the Y electrode Yi to emit the light of each color. Discharge gas such as Ne+He+Xe penning gas is filled in the discharge spaces between the front glass substrate 1 and the rear glass substrate 2. The discharge gas contains Xe of 5% and He of 30% and the total pressure thereof is 450 Torr.

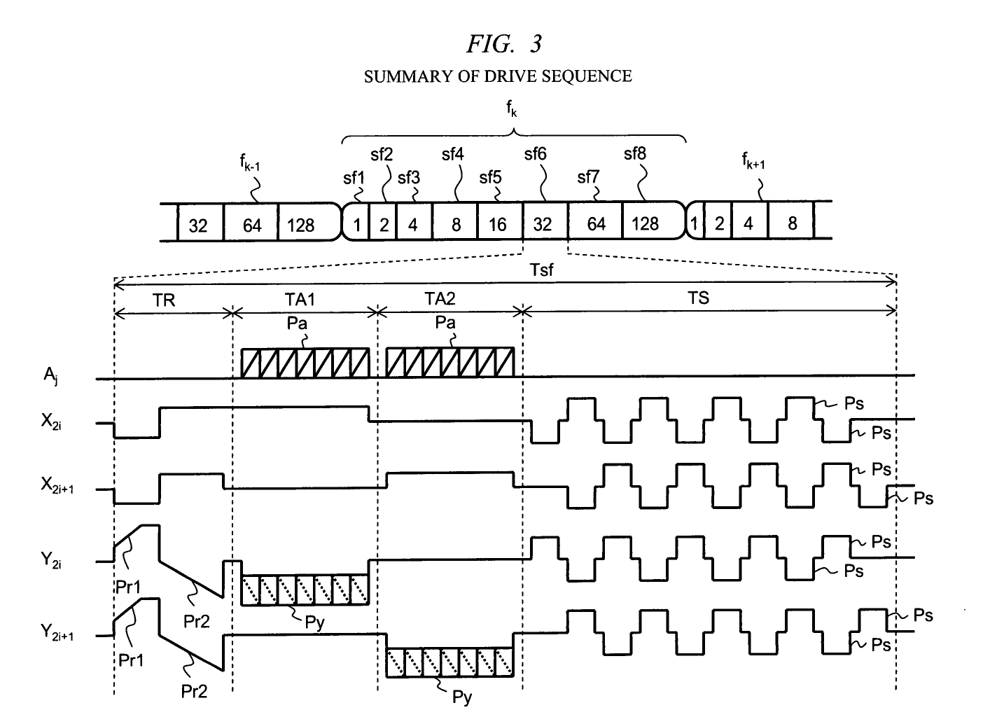

FIG. 3 is a diagram showing an example of 1 frame fk of an image according to this embodiment. An image is composed of a plurality of frames such as frames fk−1, fk, fk+1 and others. The 1 frame fk is formed of a first sub-frame sf1, a second sub-frame sf2, . . . , and an eighth sub-frame sf8. Each of the sub-frames sf1 to sf8 and the sub-frames sf1 to sf8 are collectively referred to as sub-frame sf. Each sub-frame sf has a weight corresponding to the number of grayscale bits.

Each sub-frame sf includes a reset period TR, address periods TA1 and TA2, and a sustain discharge period TS. In the reset period TR, the display cell Cij is initialized. A positive half wave (waveform with a positive slope) Pr1 and a negative half wave (waveform with a negative slope) Pr2 are applied to the Y electrode Yi.

The address period is divided into the address periods TA1 and TA2, and the light emission and the no light emission of each display cell Cij can be selected by the address discharge between the address electrode Aj and the Y electrode Yi. More specifically, a scan pulse Py is sequentially applied to even-number Y electrodes Y2, Y4, Y6, Y8, . . . in the address period TA1 and the scan pulse Py is sequentially applied to odd-number Y electrodes Y1, Y3, Y5, Y7, . . . in the address period TA2, and an address pulse Pa is applied to the address electrode Aj in accordance with the scan pulse Py. In this manner, the light emission or the no light emission of the display cell Cij can be selected.

In the sustain period TS, sustain discharge is generated between the X and Y electrodes corresponding to the selected display cell Cij to emit light. However, the sustain discharge is generated between the even-number X electrode and the even-number Y electrode and between the odd-number X electrode and the odd-number Y electrode in the even-number frame, and the sustain discharge is generated between the even-number X electrode and the odd-number Y electrode and between the odd-number X electrode and the even-number Y electrode in the odd-number frame. In other words, the interlace drive is used.

The number of light emissions by the sustain discharge pulse Ps between the X electrode Xi and the Y electrode Yi differs in the sub-frames sf. Therefore, it is possible to determine the grayscale values. The sustain discharge pulse Ps is the pulse of the voltage Vs and the voltage −Vs.

In the plasma display device for the full-spec HD TV, the number of scan electrodes (Y electrodes in this embodiment) is 1080. When the scanning of 1080 lines is performed in the normal progressive drive, the address period becomes long. As a result, the sufficient sustain period cannot be acquired, and the problem of the luminance decrease occurs. Therefore, the dual scan method in which a screen is divided into an upper screen and a lower screen and the scan of the upper and lower screens is simultaneously performed is employed. In the dual scan method, the address period can be shortened because the scan time is equivalent to that required for scanning 540 lines.

However, in the dual scan method, the address electrodes of the upper screen are extended from the upper side of the panel and the address electrodes of the lower screen are extended from the lower side of the panel. Therefore, in the case of the normal panel configuration where RGB cells are disposed in a lateral direction, the number of address electrodes is tripled from 1920 to 5760. In the current technology, there is a worry that the manufacturing yield is reduced when pitch of the extended electrodes becomes less than 0.2 mm, and the pitch of 0.2 mm or more is preferable. In this case, a length of a diagonal line of a display screen is 132 cm or longer. In other words, the productivity of the conventional full-spec HD TV using the progressive drive is low when the length of a diagonal line of a screen is shorter than 132 cm. Furthermore, the point that the number of electrodes to be connected to an address driver is doubled from 5730 to 11460 also adversely affects the manufacturing yield.

Meanwhile, since the interlace drive is used in this embodiment, the scan time is equivalent to that required for scanning 540 lines even when the single scan method is used. Therefore, the sustain period can be sufficiently acquired and the high luminance can be realized. Accordingly, since the address electrodes are alternately extended from the upper and lower sides of a panel as described in this embodiment, the pitch of the extended address electrodes can be doubled in comparison to that of the dual scan method using the progressive drive. In this embodiment, the cell pitch in a lateral direction is 0.16 mm, and the pitch of the extended address electrodes is 0.32 mm. Further, the number of electrodes to be connected to an address driver is 5730, which is half that of dual scan method using the progressive drive. More specifically, by using the configuration of this embodiment, even a panel with a length of a diagonal line of shorter than 132 cm can manufacture a plasma display device for full-spec HD TV without reducing the productivity.

### Second Embodiment

Since the number of pixels of a plasma display device for full-spec HD TV is large, an aperture ratio per one pixel is low, and thus the luminance is decreased. Therefore, it is necessary to increase the aperture ratio as much as possible. Usually, in a plasma display device which has 1024 lateral pixels, a rib with a top width of at least 50 μm is used, but in this embodiment, a thin rib with a top width of 40 μm is used. By this means, the aperture ratio can be increased. Note that, in this case, a material containing lead oxide is used as a rib material.

### Third Embodiment

In the second embodiment, a rib material containing lead oxide is used and a rib with a top width of less than 40 μm cannot be made at present. However, when a rib material containing no lead oxide is used, it is possible to select a material to which finer patterning can be performed as a photosensitive material used for the patterning to form the rib, and a thinner rib can be formed. In this embodiment, a rib material containing no lead oxide is used to form a rib with a top width of 33 μm. In other words, by using a rib material containing no lead oxide, a rib with a top width of less than 40 μm can be formed. Further, the rib material containing no lead oxide can reduce the dielectric constant, and the dielectric constant of the rib is 8.8 in this embodiment. Since the number of ribs is large in a panel for a full-spec HD TV, the reduction of dielectric constant of the ribs is effective for the reduction of the reactive power. Incidentally, the dielectric constant of the rib is 13 in the second embodiment.

### Fourth Embodiment

In the plasma display device for full-spec HD TV, since a width of a discharge space in a lateral direction is narrow, the drive voltage is high. Therefore, it is preferable that a dielectric constant of a dielectric layer of a front substrate is decreased to reduce a thickness of the layer. It is not preferable to use a high dielectric constant material to form a thin dielectric layer because the discharge current flows excessively. A usual dielectric layer contains lead oxide with a high dielectric constant, and a relative permittivity thereof is high, that is, 13 and the thickness thereof is large, that is, 32 μm. Meanwhile, in this embodiment, since lead oxide is eliminated to use a dielectric layer made of silicon oxide, the relative permittivity is low, that is, 4 and the dielectric layer with a thickness of less than 32 μm can be formed. In this embodiment, the thickness of the dielectric layer is 10 μm Accordingly, although the drive voltage is increased in general when Xe concentration is increased, the plasma display device can be driven by almost the same voltage as that of the prior art even when the discharge gas containing Xe of 10% and Ne of 90% and with the total pressure of 450 Torr is used.

The embodiments described above are merely the specific examples for carrying out the present invention, and technological scope of the present invention should not be limited by these embodiments. In other words, the present invention can be carried out in various forms within the scope of the technological idea and main features of the present invention.

What is claimed is:

1. A plasma display device comprising:
first and second substrates;
first and second electrodes for generating sustain discharge on said first substrate, said first and second electrodes being formed on said first substrate; and
third electrodes formed on said second substrate so as to generate address discharge with said second electrodes,
wherein said first to third electrodes form one pixel including cells of R, G and B, and display of 1920×1080 pixels can be made by interlace drive,
almost half of said third electrodes are connected to a drive circuit from one side of a panel, and the rest of said third electrodes are connected to the drive circuit from the other side opposite to said one side of the panel, and
a length of a diagonal line of a display area is shorter than 132 cm.

2. The plasma display device according to claim 1,
wherein said first and second electrodes other than that disposed at the end of the panel are commonly used for two display lines.

3. The plasma display device according to claim 1,
wherein said third electrodes are alternately extended from the one side and the other side opposite thereto of the panel in order of arrangement thereof and are connected to the drive circuit.

4. The plasma display device according to claim 1,
wherein ribs for defining discharge spaces are provided on said second substrate, and a top width of the rib is less than 50 μm.

5. The plasma display device according to claim 1,
wherein ribs for defining discharge spaces are provided on said second substrate, and the rib is made of a material containing no lead oxide.

6. The plasma display device according to claim 5,
wherein a top width of said rib is less than 40 μm.

7. The plasma display device according to claim 1,
wherein a dielectric layer is formed on said first substrate so as to cover said first and second electrodes, and the dielectric layer is made of a material containing no lead oxide.

8. The plasma display device according to claim 7,
wherein the material of said dielectric layer is silicon oxide.

9. The plasma display device according to claim 7,
wherein said dielectric layer has a thickness of less than 32 μm.
